(19) United States
(12) Patent Application Publication
(10) Pub. No.: US 2025/0296408 A1
(43) Pub. Date: Sep. 25, 2025

(54) Air Diffuser for a Vehicle with Air Outlet Grille and Air Outlet Grille for such an Air Diffuser

(71) Applicant: Illinois Tool Works Inc., Glenview, IL (US)

(72) Inventors: Günther Krämer, Enkenbach-Alsenborn (DE); Simon Bühler, Kaiserslautern (DE)

(21) Appl. No.: 19/073,951

(22) Filed: Mar. 7, 2025

(30) Foreign Application Priority Data
Mar. 20, 2024 (DE) 10 2024 107 953.3

(51) Int. Cl. B60H 1/34

(52) U.S. Cl. CPC B60H 1/3421; B60H 2001/3492

(57) ABSTRACT

Disclosed is an air vent for a vehicle. The air vent includes a housing and an air channel at least partially or sectionally delimited by the housing, having an air inlet end and an air outlet end. Air flowing through the air channel can flow from the air inlet end to the air outlet end along a main flow direction (H). The air vent further includes an outlet grid arranged at the air outlet end. The outlet grid includes an opening grid with grid openings spaced apart from one another by at least one web. The at least one web of the outlet grid includes an upstream inflow region and a downstream outflow region. At least one flow edge and/or step is formed in a region of the at least one web located between the inflow region and the outflow region.

### RELATED APPLICATION

The present application claims the benefit of German Patent Application No. 10 2024 107 953.3, filed Mar. 20, 2024, titled “Air Diffuser for a Vehicle with Air Outlet Grille and Air Outlet Grille for such an Air Diffuser,” the contents of which are hereby incorporated by reference.

### BACKGROUND

Air vents or air outlet nozzles are generally used in ventilation systems for vehicles, which allow the outgoing air jet to be controlled in a targeted manner. Such air vents are used to supply fresh air in particular into a vehicle interior.

The air flow flows via an inlet opening at an air inlet area of the air outflow device into the air duct bounded by the housing wall of the air outflow device, through this and finally through an outlet opening at the air outlet area of the air outflow device into the interior of a vehicle (e.g. car or truck). The air flow generally follows a main flow direction, which in particular can run at least essentially parallel to a longitudinal axis of the housing of the air outflow device.

In known air outlets, the air flow is deflected from the main flow direction by one or more air guide elements, for example pivoting air guide vanes. In addition to the air guiding elements, the housing of the air diffuser that defines the air duct can also be used to deflect the air from the main flow direction.

For design reasons, there is sometimes a desire to harmoniously integrate the outlet openings of air vents into the overall I-panel design as slot-shaped openings in such a way that the functional elements of the air vents, in particular the air guide elements/air guide vanes, are not directly visible from the vehicle interior.

### SUMMARY

The present disclosure relates generally to an air diffuser, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematic and isometric view of an exemplary embodiment of the air diffuser according to the disclosure.

FIG. 2 illustrates schematic and sectional view of the exemplary embodiment of the air diffuser according to the disclosure as shown in FIG. 1 in a side view.

FIG. 3 illustrates schematic and sectional view of the exemplary embodiment of the air diffuser according to the disclosure as shown in FIG. 1 in a plan view.

FIG. 4 illustrates schematic of an arrangement comprising an air guide element and a web of an air outlet grille according to a further aspect of the disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” “upper,” “lower,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates generally to air vents, in particular for vehicle ventilation systems. Furthermore, the disclosure relates to ventilation systems with such air vents and corresponding air vent systems.

As air vents are directly visible in the vehicle interior, they should also have a visually appealing appearance. In particular, there is a need to adapt the design and appearance of the air vents to the interior ambience. Air vents that are relatively low in height compared to their length are desirable for this purpose. However, due to their design, air deflection is rather limited.

In order to achieve a defined air deflection, the air outlets known from the state of the art generally have a height such that a certain number of air deflection blades can be arranged. The number of air guide vanes therefore also determines the maximum air deflection.

There is an increasing demand for air vents that are relatively low in height but wider in comparison. In particular, the air vents should be designed in such a way that they can be installed in the vehicle's instrument panel without the air vents or the functional elements of the air vent being visible.

One way of making air vents increasingly “invisible” in the instrument panel is to arrange an outlet grille at the air outlet end of the air duct of the air vent, which conceals the air duct with the functional elements of the air vent located behind it as seen from the vehicle interior. The air outlet grille can be designed in such a way that it corresponds to the design of the instrument panel, so that the structure of the air outlet grille is continued in the instrument panel in a suitable manner.

In particular, air vents with such grilles can be easily integrated into the surrounding components of the dashboard or instrument panel.

However, discharge grilles have the disadvantage that the air flow exiting the air duct of the air outlet is obstructed by the discharge grille. In particular, this leads to undesirable turbulence, which can greatly weaken the air flow. The finer the opening grid of the discharge grille, the more this applies.

Another negative influence on the performance of the air diffuser is the insufficient air deflection that can usually be achieved with an air outlet grille. The bars of the discharge grille create so-called “flow lobes”, which have a negative effect on the discharge behavior and, in particular, the air deflection of the air outlet. As a result, it is not possible to ensure that the target point is reached to the required extent. The formation of a flow lobe also has a negative effect on the perceptibility of the air flow if it is too wide and is more like a diffuse air flow.

However, a concentrated, perceptible air flow with good directivity is desirable.

Based on this problem, the disclosure is thus based on the task of providing an air outlet with an outlet grille in order to conceal the functional elements present in the air duct of the air outlet and to enable the desired integration in the design of the instrument panel, whereby the outlet behavior and the performance of the air outlet are not negatively influenced despite the provision of the outlet grille.

The problem underlying the disclosure is solved in particular by an air diffuser according to independent claim 1, advantageous further embodiments of the air diffuser according to the disclosure being specified in the dependent claims.

Accordingly, the disclosure relates in particular to an air outlet for a vehicle, wherein the air outlet has a housing and an air duct which is at least partially or partially delimited by the housing and has an air inlet end and an air outlet end. An air stream flowing through the air duct can flow from the air inlet end to the air outlet end along a main flow direction.

In addition, the air outlet according to the disclosure has an outlet grille arranged or arrangeable at the air outlet end or in a region of the air outlet end, wherein the outlet grille has an opening grid with grille openings spaced apart from one another by at least one web.

The air outlet according to the disclosure is characterized in particular by the fact that the at least one web of the outlet grille has an inflow area located upstream, viewed in the main flow direction, and an outflow area located downstream, viewed in the main flow direction. At least one flow edge and/or step is formed in a particularly central area of the at least one web located between the inflow area and the outflow area.

In particular, the at least one flow edge and/or step is designed in such a way that a stall occurs in the area of the at least one flow edge and/or step when the air outlet is used as intended and when air flows through the air outlet.

In fluid mechanics, a stall is the separation of the flow from the surface of an object. In the present case, the at least one flow edge and/or step of the at least one web thus serves to detach the flow from the surface of the web in the area of the at least one flow edge and/or step.

The resulting fluid mechanical effect means that the air flow no longer follows the contour of the outflow area of the at least one web. The flow separation allows the air flow to be directed freely, regardless of interface effects such as the Coandǎ effect—tendency of a fluid jet to stay attached to a surface of any form.

With a straight and angled flow through the outlet grille, the flow separation due to the at least one flow edge and/or step prevents undesired fanning out of the air flow. In other words, the fanning out of the air flow can be adjusted or reduced via the at least one flow edge and/or step.

According to embodiments of the air diffuser according to the disclosure, it is provided that the area of the at least one web located between the inflow area and the outflow area, in particular the middle area, is formed by at least one wall area extending in the main flow direction.

In particular, in embodiments of the air diffuser according to the disclosure, it is provided that the inflow area of the at least one web has at least two surfaces diverging from one another in the main flow direction. Alternatively, or additionally, it is suitable for the outflow area of the at least one web to have at least two surfaces converging towards each other in the main flow direction.

In this context, it is conceivable, for example, that the at least two surfaces diverging from one another in the main flow direction are at least partially or partially curved, in particular convexly curved. In the same way, it is also possible that the at least two surfaces converging towards each other in the main flow direction are at least partially or partially curved, in particular convexly curved.

In implementations of the air diffuser according to the disclosure, it is provided that the in particular central region of the at least one web with the at least one flow edge and/or step, viewed in the main flow direction, is arranged downstream of the inflow region of the at least one web.

It is particularly preferred that at least one upstream first flow edge and/or step and at least one downstream second flow edge and/or step are formed in the, in particular, central area of the at least one web located between the inflow area and the outflow area.

In particular in this context, in further embodiments of the air diffuser according to the disclosure, it is provided that the inflow area of the at least one web has at least one surface extending perpendicular to the main flow direction. Alternatively or additionally, it is conceivable that the outflow area of the at least one web has at least one surface extending perpendicular to the main flow direction.

Preferably, a cross-sectional area of the at least one web should be axially symmetrical, in particular with an axis of symmetry running in the main flow direction.

Thus, according to implementations of the air diffuser according to the disclosure, it is provided that the cross-sectional area of the at least one web has at least substantially or at least approximately the shape of a regular polygon, the shape of a rhombus or the shape of a deltoid (kite quadrilateral).

According to a preferred realization of the air diffuser according to the disclosure, the air diffuser has at least one air guiding element that is adjustable relative to the main flow direction and in particular relative to the housing and preferably several air guiding elements that are adjustable relative to the main flow direction and in particular relative to the housing. The at least one air guiding element can be manipulated as required, in particular manually, in such a way that at least at the air outlet of the air diffuser, the air flow flowing through the air diffuser can be deflected in a direction perpendicular to the main flow direction.

In this context, it is particularly envisaged that the at least one air guide element, viewed in the main flow direction, is arranged upstream of the outlet grille and, in particular, at a distance from the outlet grille.

According to a conceivable implementation of the last-mentioned embodiment variant of the air outflow device according to the disclosure, it is provided that, starting from a neutral position of the at least one air guide element, in which no deflection of the air flow from the main flow direction takes place by the air guide element, the at least one air guide element can be adjusted relative to the main flow direction and, in particular, relative to the housing into a first maximum position and/or into a second maximum position. In the first or in the second maximum position of the at least one air guide element, the air flow flowing through the air outlet is deflected by the at least one air guide element at least at the air outlet of the air outlet in a first direction at an angle to the main flow direction.

In particular, it is provided that the first direction runs at least substantially parallel to a direction in which at least one of the at least two surfaces of the outflow area of the at least one web of the outlet grille converging towards each other in the main flow direction extends.

In this context, “at least substantially parallel” means a direction that deviates by a maximum of 100 and preferably by a maximum of 5° from the direction in which the at least one converging surface of the outflow area of the at least one web extends.

Alternatively or in addition to the last-mentioned embodiment variant, it is provided that the first direction in which the air flow is deflected from the main flow direction with the aid of the at least one air guiding element in its maximum position runs at least substantially parallel to a direction in which at least one of the at least two surfaces of the inflow area of the at least one web of the outlet grille, which surfaces diverge from one another in the main flow direction, extends. Here too, “at least essentially parallel” means a direction that deviates by a maximum of 10° and preferably by a maximum of 5° from the direction in which one of the at least two surfaces of the inflow area of the at least one web of the outlet grille that diverge from one another in the main flow direction extends.

The grille openings of the air outlet grille can be slot-shaped, although a honeycomb design is also conceivable.

Preferably, the air outlet grille is designed to be detachable and/or replaceable with the housing of the air outlet. In particular, the outlet grille is part of a panel that is detachable and/or interchangeable with the housing of the air outflow device in an air outlet area of the air outflow device. Alternatively or additionally, the outlet grille is part of a panel mounted on the housing of the air outflow device, in particular in a detachable and/or replaceable manner.

Preferably, the outlet grille is part of a panel mounted on the housing. The outlet grille has an opening grid, which is formed by grille openings spaced apart from each other by means of several bars.

In principle, the outlet grille can be formed from parallel bars at regular intervals, similar to an arrangement of blades. In particular, the opening grid of the outlet grille can be formed by several intersecting bars. The grid openings of the air outlet grille can therefore be polygonal, for example triangular or square. In particular, the grid openings are identical and arranged at regular intervals from one another.

The air outlet grille can have a large number of grille openings, and in particular be provided with grille openings over its entire surface. The bars of the air outlet grille can have a relatively small diameter compared to the diameter of the grille openings.

The outlet grille can be made of metal or plastic, for example, whereby it is particularly preferred that the outlet grille is formed using a plastic injection molding process. If made of metal, the outlet grille is highly stable.

According to a further development of the disclosure, the air guiding elements of the air outlet form an opening grid with grid openings that are larger than the grid openings of the outlet grid. The opening grid of the air outlet grille is thus “finer” than the opening grid of the air guide elements. Due to the finer opening grid, the discharge grille provides effective visual protection, as the air guiding elements arranged in the air duct of the air outlet upstream of the discharge grille are concealed by the discharge grille. Despite the fine opening grid, the discharge grille allows the air flow to pass through the discharge grille.

Even if the grille openings are not relatively small, the formation of undesirable flow lobes can be prevented or at least reduced by providing the flow edges and/or steps on the bars of the discharge grille, as a result of which a concentrated, perceptible air flow with good directability is achieved.

The disclosure also relates to an air outlet grille for an air outlet for a vehicle, in particular for an air outlet of the type described above in accordance with the disclosure.

The air outlet grille can be detachably and in particular replaceably connected to a housing of the air outlet, in particular as part of a panel that can be detached and/or replaced in an air outlet area of the air outlet with the housing of the air outlet.

The air outlet grille according to the disclosure has an opening grid with grille openings spaced apart by at least one web. The at least one web of the air outlet grille has an inflow area located upstream, as seen in a main flow direction of the air outlet, and an outflow area located downstream, as seen in the main flow direction of the air outlet. At least one flow edge and/or step is formed in a particularly central area of the at least one web located between the inflow area and the outflow area.

The at least one flow edge and/or step is designed in such a way that a stall occurs in the area of the at least one flow edge and/or step when the air outlet is used as intended and when air flows through the air outlet.

With reference to the accompanying drawings, the disclosure is described in more detail below with reference to exemplary embodiments.

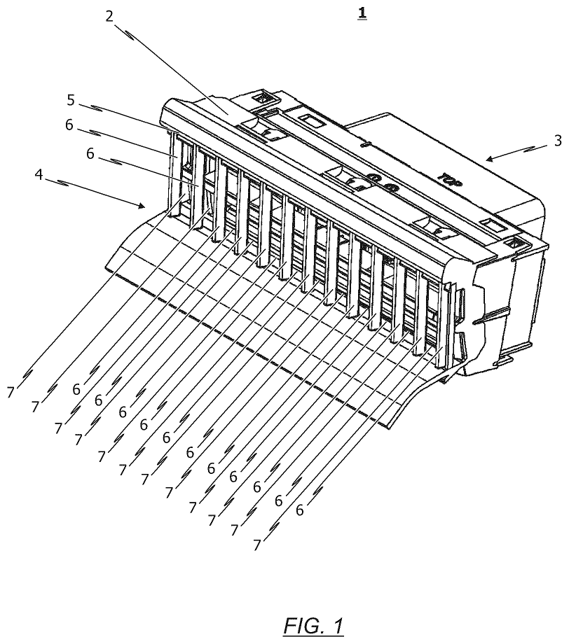

The air diffuser 1 shown schematically in FIG. 1 to FIG. 3 has a housing 2 with an air inlet end 3 and an air outlet end 4, wherein an air flow flowing through an air duct of the air diffuser 1 defined by the housing 2 can flow along a main flow direction H from the air inlet end 3 to the air outlet end 4 of the housing 2.

The exemplary embodiment of the air outlet 1 according to the disclosure is further provided with an outlet grille 5 at the air outlet end 4 or in a region of the air outlet end 4, wherein the outlet grille 5 has an opening grid with grille openings 7 spaced apart by webs 6.

The air outlet grille 5 can, for example, be part of a panel mounted on the housing 2 of the air outlet 1.

In the embodiment shown in the drawings, the outlet grille 5 is formed by parallel bars 6 at regular intervals.

In principle, however, it is also conceivable that the opening grid of the outlet grille 5 is formed by several intersecting webs 6. The grid openings 7 of the outlet grille 5 can therefore be polygonal, for example triangular or square.

In the embodiment of the air diffuser 1 according to the disclosure shown in the drawings, the grille openings 7 are identical and arranged at regular intervals from one another.

The discharge grille 5 has a large number of grille openings 7, whereby the discharge grille 5 can be provided with slot-shaped grille openings 7 over its entire surface. The webs 6 of the outlet grille 5 have a smaller diameter than the grille openings 7. The outlet grille 5 is formed in particular in the course of a plastic injection molding process.

The air outlet grille 5 forms a privacy screen, as the air guide elements 17, 18 arranged in the air duct of the air outlet 1 upstream of the air outlet grille 5 are at least partially or partially concealed by the air outlet grille 5.

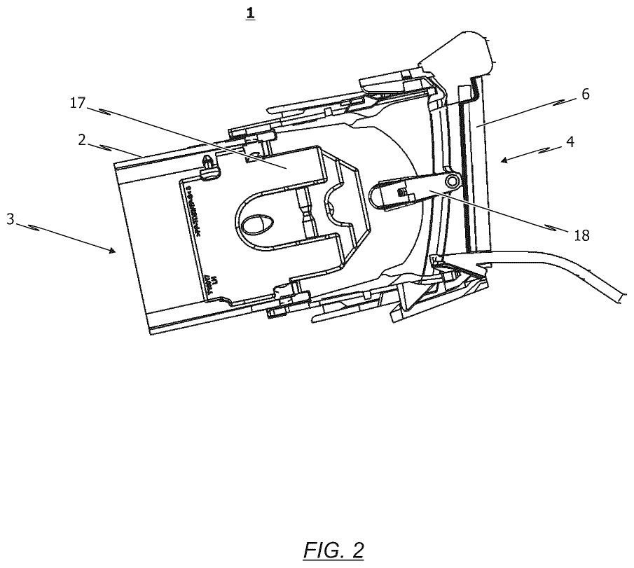

As can be seen from the schematic side sectional view according to FIG. 2, air guide elements 17, 18 are provided inside the housing 2 of the air outlet 1 for deflecting air as required. In an upstream area of the housing 2, several H-blades arranged parallel to one another are provided as (first) air deflector elements 18, which are pivotably mounted relative to the housing 2 and relative to the main flow direction H.

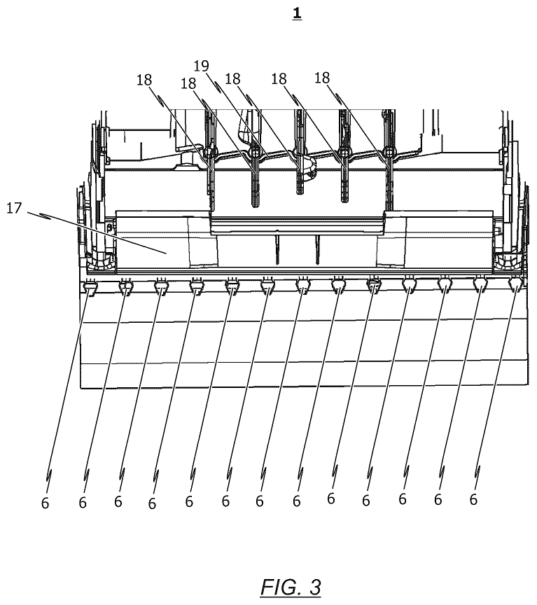

The top view in FIG. 3 shows that the H-blades are coupled to each other via a corresponding coupling rod 19 in order to synchronize their movement relative to the housing 2 of the air outlet 1.

Downstream of the blade packet of the H blades, at least one V blade arranged orthogonally to the H blades is arranged as a further air guide element 17 in order to deflect the air flow in a vertical direction relative to the main flow direction H as required.

The webs 6 of the outlet grille 5 are provided downstream and at a distance from this.

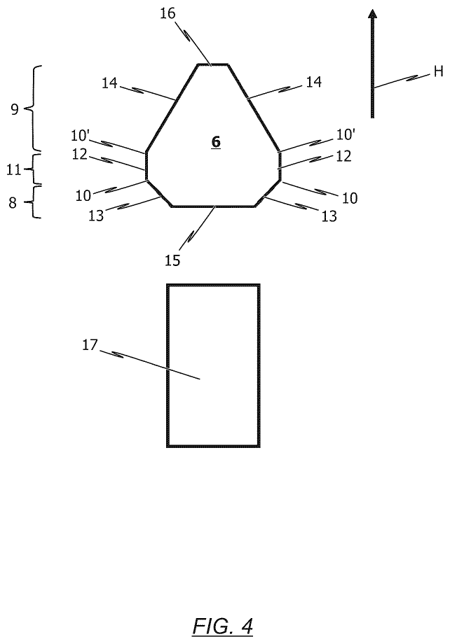

As can be seen, for example, in the schematic view in FIG. 4, each web 6 of the outlet grille 5 has an upstream inflow area 8, seen in the main flow direction H, and a downstream outflow area 9, also seen in the main flow direction H.

A central area 11 of the corresponding web 6 of the outlet grille 5 is provided between the inflow area 8 and the outflow area 9. At least one flow edge 10, 10′ or step is formed in this area 11.

In the embodiment shown in FIG. 4, two upstream first flow edges 10 and two downstream second flow edges 10′ are formed in this area 11.

The flow edges 10, 10′ are designed in such a way that when the air outlet 1 is used as intended and air flows through the air outlet 1, a stall occurs in the area 11 of the flow edges 10, 10′.

In the embodiment variant of the webs 6 of the outlet grille 5 shown in FIG. 4, the central area 11 of the web 6 is formed by a wall area 12 of the web 6 extending in the main flow direction H.

Furthermore, it can be seen in particular from the sectional view according to FIG. 4 that the inflow area 8 of the web 6 has two surfaces 13 diverging from each other in the main flow direction H and the outflow area 9 of the web 6 has two surfaces 14 converging towards each other in the main flow direction H.

Although not shown in FIG. 4, it is also conceivable in principle that the two surfaces 13 diverging towards each other in the main flow direction H and/or the two surfaces 14 converging towards each other in the main flow direction H are at least partially or partially curved, in particular convexly curved.

The central area 11 of the web 6 with the corresponding flow edges 10, 10′ and/or steps is arranged downstream of the inflow area 8 of the web 6, as seen in the main flow direction H.

Furthermore, in the schematic embodiment shown in FIG. 4, it is provided that the inflow area 8 of the web 6 has a surface 15 extending perpendicular to the main flow direction H, and that the outflow area 9 of the web 6 has a surface 16 extending perpendicular to the main flow direction H.

The cross-sectional area of the web 6 is designed to be axially symmetrical, in particular with an axis of symmetry running in the main flow direction H.

In the embodiment shown in FIG. 4, for example, it is provided that the cross-sectional area of the web 6 is at least substantially in the shape of a deltoid, although other shapes are also conceivable, for example the shape of a regular polygon or the shape of a rhombus.

The at least one air guide element 18 of the air outlet 1, which is arranged immediately adjacent upstream, can be manipulated manually in particular in such a way that the air flow flowing through the air outlet 1 can be deflected in a direction perpendicular to the main flow direction H, at least at the air outlet of the air outlet 1. This at least one air guide element 18, viewed in the main flow direction H, is arranged upstream of the outlet grille 5 and in particular at a distance from the outlet grille 5.

Starting from a neutral position, the at least one air guiding element is adjustable relative to the housing 2 of the air outlet 1 and relative to the main flow direction H into a first and second maximum position, wherein in the maximum position of the at least one air guiding element 18, the air flow flowing through the air outlet 1 is deflected by the air guiding element at least at the air outlet of the air outlet 1 in a first direction at an angle to the main flow direction H.

Preferably, the first direction runs at least substantially parallel to a direction in which one of the two surfaces 14 of the outflow area 9 of the web 6 of the outlet grille 5, which converge towards each other in the main flow direction H, extends.

Alternatively or additionally, it is advantageous for the first direction to run at least substantially parallel to a direction in which at least one of the two surfaces 13 of the inflow area 8 of the web 6 of the outlet grille 5, which diverge from each other in the main flow direction H, extends.

In brief, the disclosure enables a directable and at least substantially concentrated air flow with the aid of a special design of the webs 6 of the outlet grille 5. The formation of a suitable outlet grille 5 is based on a suitable cross-section of the webs 6 in the outlet grille 5

Due to the aerodynamics, a rhombus or a cross-section approximating a kite square (deltoid) is suitable in this context. The edges/flow edges 10, 10′ of the cross-section approximating a diamond shape or a deltoid can also be rounded to form an oval or ovoid.

The formation of a suitable lattice 5 is based on a suitable cross-section of the bars or webs 6 in the lattice 5. For reasons of aerodynamics, the choice initially fell on a cross-section approximating a rhombus or a kite quadrilateral. The edges of the cross-section approximating a diamond shape or kite quadrilateral can also be rounded to an oval or egg shape. The rhombus, the kite square, the oval or the ovoid is suitably aligned in the direction of flow. Naturally, such a grid 5 is formed by a number of longitudinal and transverse bars, which can be positioned as required.

Not only right-angled but also oblique-angled arrangements can be realized. Honeycomb arrangements are also possible.

In the embodiment shown here, a kite quadrilateral is arranged on its longer axis in the direction of flow H and flattened at the tips located in the direction of flow H. The angles of the kite quadrilateral are adapted to the deflection angles to be achieved.

This cross-section enables both a straight flow through the grille 5 and a flow at an angle. The inclines created by the kite square cross-section help to maintain the flow direction through the grille 5.

With rectangular cross-sections of the grille bars/bars 6, the air flow at the grille bar 6 is deflected again in a straight direction and the resulting deflection of the air jet falls short of expectations.

An edge 10, 10′ is created on the sides of the kite quadrilateral for geometric reasons. The flow is separated at this edge 10, 10′. This flow separation allows the airflow to be directed freely, independent of boundary layer effects such as the Coanda effect.

With straight and angled air flow, a trailing edge 10′ prevents unwanted fanning of the air flow. The fanning out can be adjusted via this edge 10′.

In order to strengthen or weaken this effect accordingly, a step can also be inserted at this point, the height of which can be varied according to requirements. Such a step is also conducive to the manufacturability of the grille 5 in an injection molding process.

It has been shown that it is advantageous to maintain a certain distance between the air-guiding elements 17, 18 in the air outlet 1 and the grille 5 in order to ensure pressure equalization between the side facing the flow and the side facing away from the flow, e.g. with an air-guiding element 17, 18 in an angled position.

A significant gap between grille 5 and the air flow guiding element 17, 18 also allows a cross flow, which minimizes these undesirable effects, such as straightening of the air flow, through the grille 5.

Another advantage can be to keep the grille 5 at a distance from the housing 2 of the air outlet 1. Especially in the edge areas on the housing 2 and the grille 5 of the air outlet 1, which in this case is in direct contact, undesirable pressure cushions lead to a straightening of the air flow.

Spacing with an essentially free flow allows pressure equalization and drainage of the pressure poster.

An orifice often protrudes into the diffuser 1 from the outside. When designed as grille 5, this overhang can be enlarged. In this case too, the spacing of the grille 5 has a positive effect on the deflection of the air flow.

The special geometry of the cross-section of the grille bars 6 even increases the deflection of the air jet. This is achieved by cleverly exploiting the pressure conditions on the individual grille bar 6.

If the inclined air flow hits the grille 5 at the trailing edge 10′, it is applied to the surface 14. At the opposite trailing edge 10′, however, the flow breaks off and creates a negative pressure zone on the opposite surface 14.

Furthermore, a wake vortex is created on the side 14 facing the flow at the tear-off edge 10′, which fills the negative pressure zone on the opposite surface 14.

This effect deflects the air flow in the direction of the side facing away from the flow. In an arrangement with several grille bars 6, this effect is amplified and influences the entire air flow.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SYMBOLS

1 Air vents
2 Housing
3 Air inlet end
4 Air outlet end
5 Outlet grille/grille
6 Bar
7 Grille opening
8 Incoming flow range
9 Outflow area
10 Flow edge/step
11 Medium range
12 Wall area of the middle section
13 diverging surface
14 Converging surface
15 Surface of the inflow area extending perpendicular to the main flow direction
16 Surface of the area extending perpendicular to the main flow direction
17 Air guiding element (V-slat)
18 Air guiding element (H-slat)
19 Coupling rod
H Main stream direction H

What is claimed is:

1. An air diffuser (1) for a vehicle, the air diffuser (1) comprising the following:
a housing (2);
an air duct at least partially or partially delimited by the housing (2) and having an air inlet end (3) and an air outlet end (4),
wherein an air flow flowing through the air duct can flow from the air inlet end (3) to the air outlet end (4) along a main flow direction (H); and
an outlet grille (5) arranged or arrangeable at the air outlet end (4) or in a region of the air outlet end (4),
wherein the outlet grille (5) has an opening grid with grille openings (7) spaced apart by at least one web (6), and
wherein the at least one web (6) of the outlet grille (5) has an inflow region (8) located upstream, as seen in the main flow direction (H), and an outflow region (9) located downstream, as seen in the main flow direction (H), at least one flow edge (10, 10′) and/or step being formed in a region (11) of the at least one web (6) located between the inflow region (8) and the outflow region (9).

2. The air diffuser (1) according to claim 1,
wherein the at least one flow edge (10, 10′) and/or step is designed in such a way that a stall occurs in the region (11) of the at least one flow edge (10, 10′) and/or step when the air diffuser (1) is used as intended and when air flows through the air diffuser (1).

3. The air diffuser (1) according to claim 1, wherein the region (11) of the at least one web (6) located between the inflow region (8) and the outflow region (9) is formed at least partially or in some areas by at least one wall region (12) extending in the main flow direction (H).

4. The air diffuser (1) according to claim 1,
wherein the inflow region (8) of the at least one web (6) has at least two surfaces (13) diverging from one another in the main flow direction (H); and/or
wherein the outflow region (9) of the at least one web (6) has at least two surfaces (14) converging towards each other in the main flow direction (H).

5. The air diffuser (1) according to claim 4,
wherein the at least two surfaces (13) diverging from one another in the main flow direction (H) are at least partially or partially curved; and/or
wherein the at least two surfaces (14) converging towards each other in the main flow direction (H) are at least partially or partially curved.

6. The air diffuser (1) according to claim 1,
wherein the region (11) of the at least one web (6) with the at least one flow edge (10, 10′) and/or step, viewed in the main flow direction (H), is arranged downstream of the inflow region (8) of the at least one web (6).

7. The air diffuser (1) according to claim 1,
wherein at least one upstream first flow edge (10) and/or step and at least one downstream second flow edge (10′) and/or step are formed in the region (11) of the at least one web (6) lying between the inflow region (8) and the outflow region (9).

8. The air diffuser (1) according to claim 1,
wherein the inflow region (8) of the at least one web (6) has at least one surface (15) extending perpendicular to the main flow direction (H); and/or
wherein the outflow region (9) of the at least one web (6) has at least one surface (16) extending perpendicular to the main flow direction (H).

9. The air diffuser (1) according to claim 1,
wherein a cross-sectional area of the at least one web (6) is designed to be axially symmetrical, namely with an axis of symmetry extending in the main flow direction (H).

10. The air diffuser (1) according to claim 9,
wherein the cross-sectional area of the at least one web (6) has at least substantially or at least approximately the shape of a regular polygon, the shape of a rhombus or the shape of a deltoid.

11. The air diffuser (1) according to claim 4, wherein the air diffuser (1) comprises at least one air guiding element (17, 18) adjustable relative to the main flow direction (H) and a plurality of air guiding elements (17, 18) adjustable relative to the main flow direction (H), which air guiding element(s) (17, 18) is configured to be manipulated in such a way that at least at the air outlet end (4) of the air diffuser (1) the air flowing through the air diffuser (1) is/are adjustable, which is configured to be manipulated in such a way that at least at the air outlet end (4) of the air outlet (1) the air flow flowing through the air outlet (1) is configured to be deflected in a direction perpendicular to the main flow direction (H), wherein the at least one air guide element (17, 18), viewed in the main flow direction (H), is arranged upstream of the outlet grille (5).

12. The air diffuser (1) according to claim 11,
wherein, starting from a neutral position of the at least one air guiding element (17, 18), the at least one air guiding element (17, 18) is adjustable relative to the main flow direction (H) into a first maximum position and/or into a second maximum position,
wherein, in the first or in the second maximum position of the at least one air guiding element (17, 18), the air flow flowing through the air outlet (1) from the at least one air guiding element (17, 18) at least at the air outlet end (4) of the air outlet (1), the air flow flowing through the air outlet (1) is deflected in a first direction at an angle to the main flow direction (H), and
wherein the first direction extends at least substantially parallel to a direction in which at least one of the at least two surfaces (14) of the outflow region (9) of the at least one web (6) of the outlet grille (5) converging towards each other in the main flow direction (H) extends.

13. The air diffuser (1) according to claim 4, wherein, starting from a neutral position of the at least one air guiding element (17, 18), the at least one air guiding element (17, 18) is adjustable relative to the main flow direction (H) into a first maximum position and/or into a second maximum position, wherein, in the first or second maximum position of the at least one air guiding element (17, 18), the air flowing through the air diffuser (1) is deflected by the at least one air guiding element (17, 18) at least at the air outlet of the air diffuser (1), the air flow flowing through the air diffuser (1) is deflected in a first direction at an angle to the main flow direction (H), the first direction extending at least substantially parallel to a direction in which at least one of the at least two surfaces (13) of the inflow region (8) of the at least one web (6) of the diffuser grille (5), which surfaces diverge from one another in the main flow direction (H), extends.

14. The air diffuser (1) according to claim 1, wherein the grille openings (7) of the outlet grille (5) are slot-shaped or honeycomb-shaped.

15. The air diffuser (1) according to claim 1, wherein the outlet grille (5) is designed to be detachable and/or replaceable with the housing (2) of the air outlet (1), and wherein the outlet grille (5) is part of a panel which is detachable and/or replaceable with the housing (2) of the air outlet (1) in an air outlet region of the air outlet (1) and/or part of a panel which is mounted on the housing (2) of the air outlet (1) in a detachable and/or replaceable manner.

16. An air assembly for a vehicle comprising:
the air outlet (1) of claim 1; and
an outlet grille (5),
wherein the outlet grille (5) is configured to be detachably and/or replaceably connected to a housing (2) of the air outlet (1) as part of a panel in an air outlet region of the air diffuser (1) with the housing (2) of the air diffuser (1),
wherein the outlet grille (5) has an opening grid with grille openings (7) spaced apart from one another by at least one web (6),
wherein the at least one web (6) of the outlet grille (5) has an inflow region (8) located upstream, as seen in a main flow direction (H) of the air outflow device (1), and an outflow region (9) located downstream, as seen in the main flow direction (H) of the air outflow device (1), and
wherein at least one flow edge (10, 10′) and/or step is formed in a particularly central region (11) of the at least one web (6) lying between the inflow region (8) and the outflow region (9).

17. The air assembly according to claim 16, wherein the at least one flow edge (10, 10′) and/or step is designed in such a way that a stall occurs in the region (11) of the at least one flow edge (10, 10′) and/or step when the air outlet (1) is used as intended and when air flows through the air outlet (1).
